(19) United States
(12) Patent Application Publication
(10) Pub. No.: US 2017/0195666 A1
(43) Pub. Date: Jul. 6, 2017

(54) MULTI PERSON VIEWABLE 3D DISPLAY DEVICE AND FILTER GLASSES BASED ON FREQUENCY MULTIPLEXING OF LIGHT

(71) Applicant: Sai Akhil Reddy Konakalla, La Jolla, CA (US)

(72) Inventor: Sai Akhil Reddy Konakalla, La Jolla, CA (US)

(21) Appl. No.: 15/253,998

(22) Filed: Sep. 1, 2016

(30) Foreign Application Priority Data
Sep. 25, 2015 (IN) 984/KOL/2014

(51) Int. Cl. H04N 13/04; A63F 13/26

(52) U.S. Cl. CPC H04N 13/0497; H04N 13/044; A63F 13/26; A63F 2300/8082

(57) ABSTRACT

The present invention deals with a multi-person viewable 3-D display TV which comprises of a liquid crystal display (LCD) screen with backlights at multiple frequency ranges, a multidimensional control circuit to control information signals independently, a set of frequency filter visual glasses and audio apparatus integrated with the glasses. The LCD screen is made to display different pictures simultaneously on the full area of the screen, each at a particular frequency range different with others. This is fulfilled by proper pixel grid arrangement, effective controllability of pixels and correct sub-pixel addressing. A frequency channel is defined as the range of frequencies which contains the complete information of the video picture on the screen. The TV control circuit processes different audio and video (RF/IF) signals of different frequency channels independently, each in a similar methods as in a conventional LCD TV. The viewer's visual glass is configured to selectively enable the viewer to be able to view pictures of a particular frequency channel through the glass based on the signals from a processor. Thus, multiple pictures through different frequency channels are displayed simultaneously on the single LCD screen and are selectively viewed by different viewers depending on the glasses that they wear. Methods, devices, and systems to implement the above mentioned invention are hereby disclosed.

### CROSS-REFERENCE TO RELATED APPLICATIONS

This application claims the benefit of Indian Patent Application 984/KOL/2014, filed Sep. 25, 2015, and incorporated by reference herein in its entirety.

### BACKGROUND OF THE INVENTION

(1) Field of the Invention

The present invention relates to systems that incorporate a display, associates with a frequency filter glass. In particular the invention relates to a display screen which simultaneously displays images from more than two video feeds.

(2) Description of the Related Art

Presently, most displays have the capability to provide one video: television program or a game to all the viewers of that display. As an example, all players of a given video game can view the same graphics from the monitor, and as a result, different visual information cannot be provided to different players unless a more complex, expensive and not so convenient type of display such as a head mounted monitor is used.

Similarly, present TVs incorporate displays that can provide more than one video game or television program at the same time but require all viewers to view images from each of the displayed television programs/videos such as by splitting the display screen or by providing a picture within a picture. Moreover, the audio portion of only one such television program or a game can be provided at a time for that audio portion to be available.

Therefore, it is desirable to have a screen sharing apparatus where two or more viewers can view different images on the same display, so that a viewer does not require to view the images intended for another viewer. Also it is desirable to have independent audio signals for each viewer, related to the video/program the viewer is watching.

However, there is known a screen sharing technique using a time multiplexing or sharing technique where two discrete video signals are fed and then alternately displayed on the entire screen, at different time instants. This invention uses 3D shutter glasses to enable each viewer to be able to see a particular video. The present invention greatly differs from that, by its fundamental principle of operation and also the different apparatus to be used in the system.

The present invention has all the advantages to that of the previous invention plus added features like absolutely no flickering effect, increased number of viewers, a more resilient 3D display and can also be used as a conventional LCD TV if there is only one viewer i.e. without any glasses.

### BRIEF SUMMARY OF THE INVENTION

The present invention provides a television system in which a screen which simultaneously displays images from more than two video feeds in different frequency channels. The present invention discloses systems, methods, and devices that are needed in order to perform the invention. A frequency channel is defined as the range of frequencies which contains the complete information of the video picture on the screen.

The system also consists of adjustable frequency filter glasses which are synchronized to the screen so that they pass through them a single frequency channel video feed to each viewer wearing them.

A frequency channel video feed may be represented as any video content, video stream, channel, game output, cable channel, video output from a consumer electronic device, DVR, DVD player, motion picture etc. Video feeds may be sourced from one or more physical cables or through one or more internal buses or through any known means for sourcing video images.

‘Screen Sharing’ as described herein may generally refer to a frequency-sharing arrangement where multiple users can simultaneously view programming on a single television screen using the full dimensions and wearing visual glasses to coordinate each user view of programs.

According to an aspect of the invention, respective video feeds are provided to at least two viewers using a common display. The display is controlled to simultaneously project on it different video feeds in different frequency channels so that the assigned viewer can decode the content of a particular channel with the set of glasses.

A frequency filter glass is set to display such that it filters out the video feeds falling in all the other frequency channels except the frequency channel assigned to the particular filter glass.

As a result, only a single video feed is provided to each viewer although the screen emits the video feeds of many more video feeds in different frequency channels.

Multiple video feeds are produced on the LCD screen using the LCD backlight at different frequency ranges that do not overlap with each other and lie outside the conventional visible range of light. However, there can be a single video feed which could fall in the visible range so that one viewer may not need a filter glass to watch the video.

Also the intensities of the light coming out of the screen must be correctly optimized in a way that the filtering and translation of light into visible light before it enters the viewer's eye is possible, and the light does not cause any harm to the naked/aided human eye.

The grid arrangement of the LCD and the placement of the twisted nematics (TN) is very important for such a display to work in a proper way. The twisted nematics used in this invention serve the same purpose as those in the conventional LCD screens except that they act on the light at a different frequency than that of the visible light with R-G-B attributes. The R-G-B attributes are achieved for the light at non-visible frequencies once they are filtered and translated to the visible light.

Active filtering of light and translation of light into visible light is the primary task of the frequency filter glasses.

The present invention can also apply to solve in a more better way, the issue of multi-player split screen game where traditional screens are divided into 2 or 3 portions and players sit side-by-side and play a game watching one screen with all the player perspectives each occupying a part of the screen.

According to the further aspect of the invention, a multi-player video game, and a video program can be provided to multiple users in 3D using the single display.

The foregoing aspects, features and advantages of the present invention will be further appreciated when considered with reference to the following detailed description and drawings.

### BRIEF DESCRIPTION OF THE SEVERAL VIEWS OF THE DRAWINGS

FIG. 1 shows a diagram illustrating an example of a display and associated pairs of frequency filter glasses that operate in accordance with the aspect of the invention.

FIG. 2 shows a diagram showing the sequence of frames presented by the display of FIG. 1 at different frequencies and showing the frames viewed by each viewer of a given pair of frequency filter glasses in accordance with an aspect of the invention.

FIG. 3 shows representational drawing of people watching different audio/video content on the same screen in accordance with an aspect of the invention.

FIG. 4 shows an isometric view of glasses and headphones in accordance with an aspect of the invention.

FIG. 5A shows representational drawing of light emanating from the screen and passing through the filter lens before reaching the eye of the viewer in accordance with an aspect of the invention.

FIG. 5B shows a system diagram showing the block representation of the elements inside the frequency filter glasses.

FIG. 6 shows a system diagram of glasses in accordance with an aspect of the invention.

FIG. 7 shows a system diagram of a screen sharing apparatus, in communication with a television or a monitor and multiple inputs, in accordance with an aspect of the invention.

FIG. 8 shows a functional diagram of 3-D content being provided to a user in accordance with an aspect of the invention.

FIG. 9 shows a functional diagram of different television channels being provided to multiple users in accordance with an aspect of the invention.

FIG. 10 shows a functional diagram of different television channels being provided to multiple users with 3-D content enabled in accordance with an aspect of the invention.

FIG. 11 shows a functional diagram of different television channels being provided to multiple users with user-optional 3-D content enabled in accordance with an aspect of the invention.

### DETAILED DESCRIPTION OF THE INVENTION

As used herein, the singular forms “a”, “an” and “the” are intended to include the plural forms as well, unless the context clearly indicates otherwise. Additionally, the use of “or” is intended to include “and/or”, unless the context clearly indicates otherwise.

The present invention provides the use of a single display screen to present respective video feeds to two or more viewers in a way to allow each viewer see the images from the video feed intended for the particular viewer.

The audio signals are also meant to be unique for different viewers and are transmitted through the wireless transmitter in the TV and are received by a receiver mounted on the frame of glasses worn by the viewers.

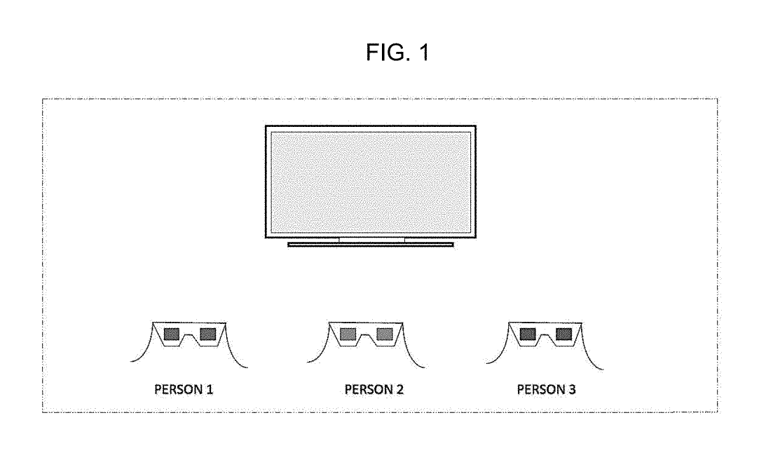

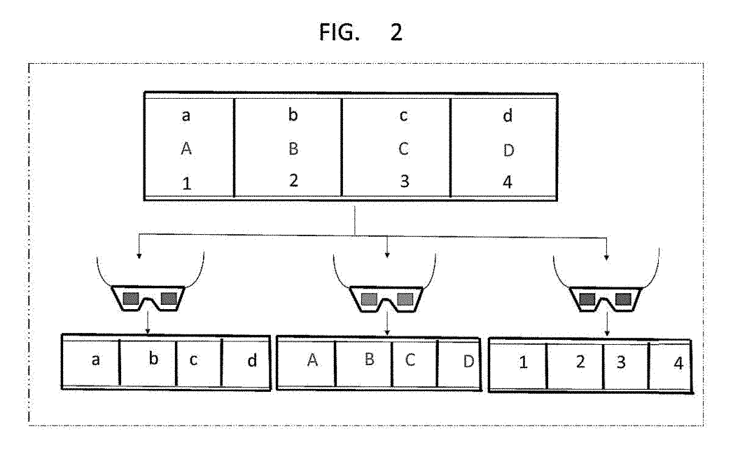

FIG. 1 illustrates an example of the invention where three viewers, PERSON 1, PERSON 2, and PERSON 3 view the same screen. In FIG. 2 each of the three viewers view either a first video feed of frames a, b, c, . . . , a second video feed A, B, C, . . . and a third video feed of 1, 2, 3, . . . on the same screen. The screen simultaneously displays an image from each video feed, resulting in display of [a, A, 1] at an instant [b, B, 2] at the next instant, [c, C, 3] in the next instant and so on.

The methods of various embodiments of the present disclosure may be carried out by hardware, software, firmware, or a combination of any of the foregoing. A first frequency filter, such as the leftmost of the three pairs of filter glasses depicted in FIG. 2, is designed to pass through it the first video feed that is in the frequency channel assigned to it. The first frequency filter thus helps to block the video feeds of all the other frequency channels except the first itself. The light passed through the filter is then translated to the visible light before it exits the glass apparatus.

An individual viewing the monitor through the first frequency filter glass, for example by wearing the leftmost pair of filter glasses, would therefore only see the frames of the first video feed and would not see the frames of any other video feeds, as shown in the leftmost bottom portion of FIG. 2.

The section of the lens of a pair of frequency filter glasses to be used may be realized by any means known in the art, for example using frequency mixers with crystals for frequency translation like in known standard methods for example Second Harmonic Generation (SHG) for up-conversion or down-conversion of light containing the video feed into eye visible light.

The other part of the filter glasses, used for blocking other frequencies using frequency filters can be achieved by any means known in the art, for example using frequency selective films such as oxide films which can pass the light of a particular range of frequencies through them, and serving the purpose of the frequency filters.

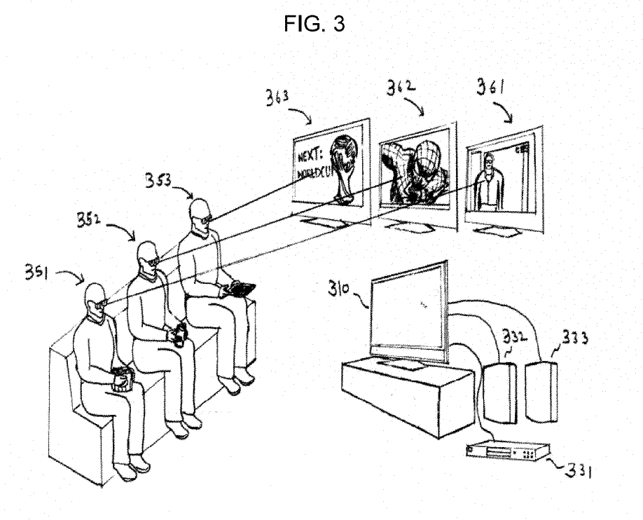

Each viewer may also be provided with an earphone or headphone that provides audio for the relevant video feed the viewer is watching as depicted in FIG. 3.

A first audio feed associated with the first video feed is provided to the viewer using the earphones mounted on the first pair of glasses and the second audio feed associated with the second video feed is provided to the viewer using the earphones mounted on the second pair of glasses.

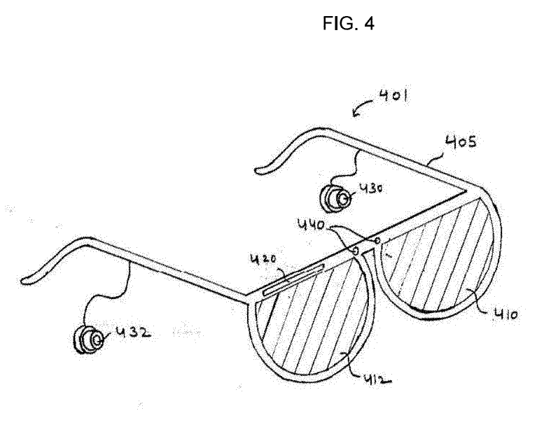

The example of a pair of glasses 401 shown in FIG. 4 can be provided with earphone or headphone to hear the sounds for the respective video feed being viewed without interference from the sounds provided to the viewer of other video feeds.

The glasses include a frame 405 for holding left eyeglass filter lens 410 and a right eyeglass filter lens 412. As noted above, each eyeglass lens 410 and 412 are designed to pass through the frequency of the particular video feed only. Left and right earphones 430, 432 are also mounted on the frame and are connected to the wireless transmitter and receiver.

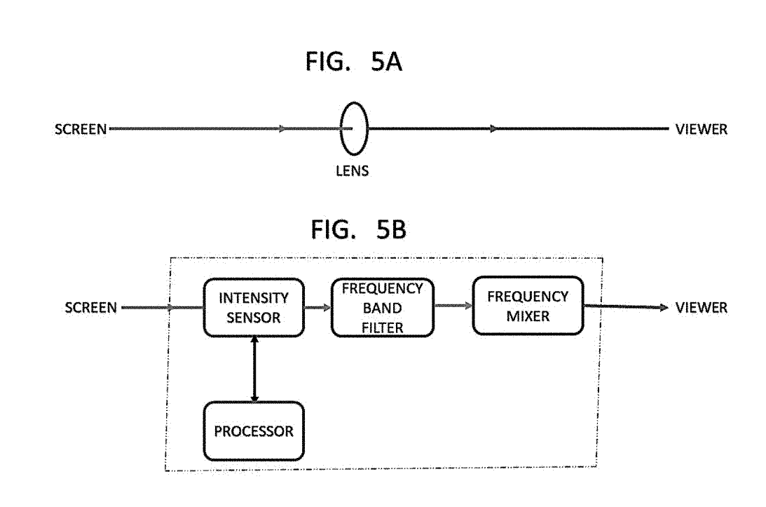

An antenna 420 for receiving and sending wireless signals such as audio and filter control signals may also be mounted on the frame. For active filtering, the glasses are made to track the intensity of the incident light via sensors which are placed on the glasses. The sensors comprise photo detectors 440 which generate a voltage signal proportional to the intensity of light incident on them. These signals are sent into a processor which regulates the filtering process i.e. block all the incident light, irrelevant of its frequency if the intensity of the light is below a threshold value or if the intensity crosses the limit which may be harmful to the human eye. These photodetectors are different for different range of frequencies of the incident light and hence vary from glass to glass. FIG. 5A depicts an overview of the functionality of the lens to process the light from the screen to each eye of the viewer. The block level functionalities are presented in FIG. 5B, which illustrates how the light emanating from the screen is processed before it can reach the human eye.

The simultaneous display of video feeds can thus be realized as a combination of light with different frequencies superimposed on a single screen and then selectively filtered and translated back to the viewable form by each visual glass corresponding to each viewer as shown in FIG. 5B.

The difficulties in time slicing or interlacing or interleaving technique such as flickering, poor resolution due to limitations in human eye perception, and necessity of wearing glasses for all the viewers can easily be addressed using the frequency division technique.

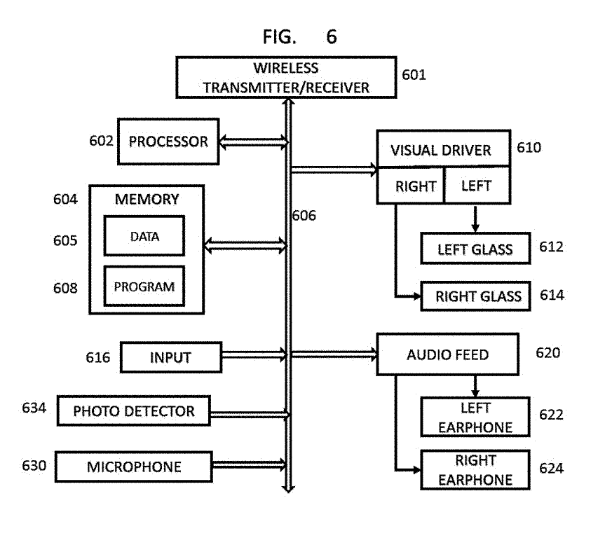

A system of glasses in accordance with the present invention is shown in FIG. 6. The glasses include a Processor 602 which executes the instructions from Program 608 stored in Memory 604. Memory 604 stores data to be provided to, or output from, Processor 602 as well as any other storage retrieval/storage element of the glasses. Processor 602, memory 604 containing data memory 605 and program memory 608, filter glasses 401, antenna 420 and other elements communicate with each other over a bus 606. The audio and video signals are communicated to the visual driver 610 comprising of left glass 612 and right glass 614 and to the audio feed 620 containing the left earphone 622 and the right earphone 624.

The frequency range of the channel, cut-off frequency for filtering, threshold and maximum intensity canonical data can be stored in advance in the glasses. Also these attributes can be selected via means of user input 616 (example knobs or buttons to adjust desired parameters like brightness, volume etc.)

The glasses can also include a microphone 630 which can be used for voice communication required for gaming and these signals can be transmitted to the game console or another device via transmitter/receiver 601.

The glasses may also include an array of detectors 634. These can be used to determine whether the desired frequency range is contained in the feed and also to determine when to switch off and on the glass depending on the intensity of light. These photo-detectors vary from viewer's glasses to glass depending on in which frequency channel their video feed lies in.

If the processor detects substantial drop in light intensity i.e. when the viewer looks away from the screen, the frequency filters and translators switch off and the person is able to view other things in the room normally. Thus, these can also act as smart glasses which switch on and off depending on the light that falls on them.

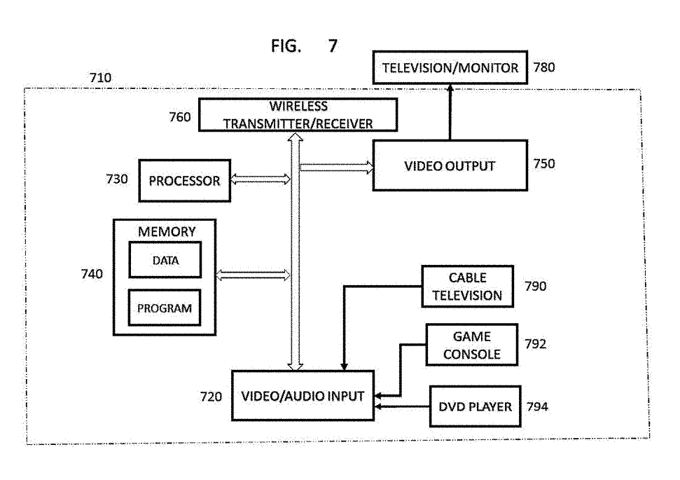

A system diagram of one aspect of the proposed screen sharing apparatus 710 which provides the video that is to be displayed, is illustrated in FIG. 7. A video/audio input 720 accepts two or more video and audio inputs such as but not limited to, and preferably in any combination, from a cable television set top box 790, game console 792, and a DVD player 794.

The single video stream can be a frequency multiplexed sequence of videos characterized by two or more video feeds or inputs. Also, the video inputs need not be sourced from multiple devices, rather a single device can be capable of presenting two or more video inputs. The audio is transmitted separately to the hearing apparatus of each viewer via a wireless transmitter/receiver as in 760. Processes such as and not limited to audio/video synchronization, channel selection, memory handling and remote controls are handled by the main processor 730 which has access to the data and program memory 740.

Although the screen sharing apparatus 710 is schematically illustrated being separate from the television 780 and video inputs in FIG. 7, the apparatus with video output 750, may be located in a wide variety of devices. For example the screen sharing apparatus 710 may be embedded in a set top box having multiple inputs.

Although the figures depict the screen sharing for only three viewers in FIG. 1 and FIG. 2, the invention is applicable to more number of video feeds with more viewers.

Although the figures depict that all the viewers must wear frequency filter glasses, there may be one viewer who may not wear a glass and watch the screen like a normal television in the visible range of light. This means that the invention can also be used as a single viewer television, which may not be possible in previous screen sharing inventions. FIG. 3 shows an embodiment of the invention in which a set top box receives various channels and/or videos, such as for example a World Cup Soccer Match, a television show ‘The Big Bang Theory’ (TBBT) and a movie Spiderman. The control system then controls the monitor to simultaneously display images from each channel/video on a different frequency channel. The processor in the visual glass controls each of the filter glass to allow the viewer to view only one of the three programs/videos. The processor also simultaneously receives the audio signal via the receiver and thus sends these signals to the earphones of the viewer to hear the audio portion of that program like for example Soccer Commentary, Sheldon's (a character in TBBT) dialogue, or the Spiderman's stunt music.

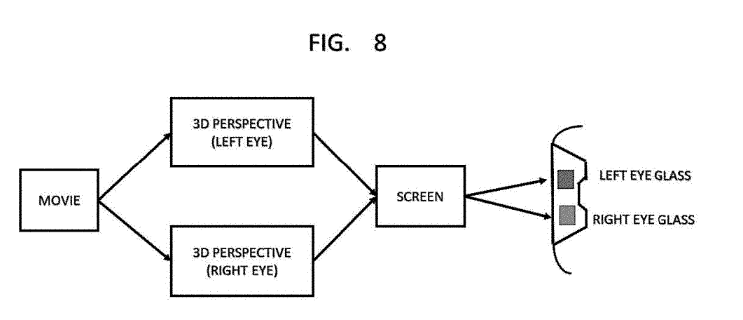

As shown in FIG. 8, the present invention can also provide a three-dimensional view of a video which means it can also be effectively used as a 3D TV. For this, the left and right filter glasses must filter frequencies falling in different frequency channels before conversion into visible light entering the viewer's eye. This provides different perspectives to the left and right eye, which is the effect of 3D.

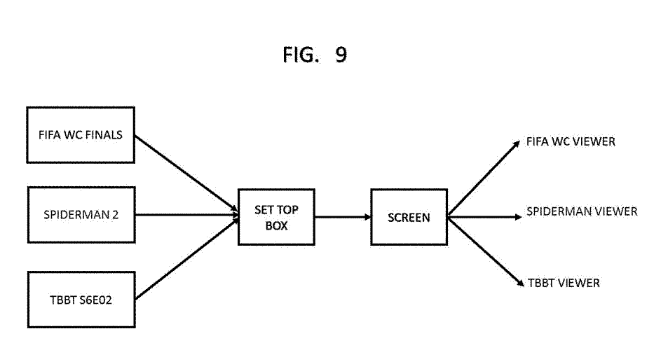

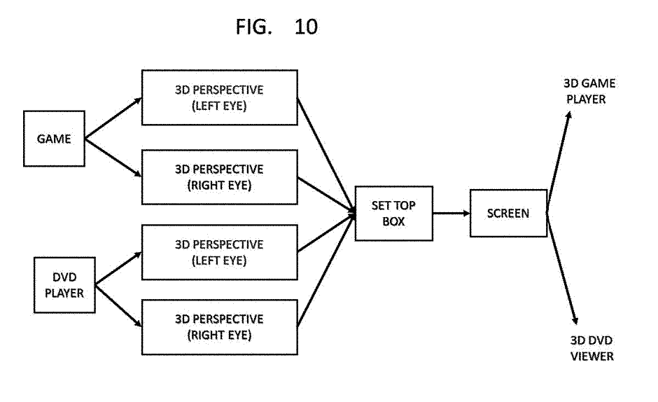

To attain the 3D effect, the left and right glasses of each pair of filter glasses are used at different ranges of frequencies. FIG. 9 clearly depicts how the three different video feeds from a single setup box are displayed simultaneously on a single screen to enable video for three viewers. As a result, each viewer of a television program views it in 3D at the same time as well as from his or her perspective as illustrated in FIG. 10. Thus, the present invention has a better edge for 3D TV than the earlier screen sharing 3D inventions.

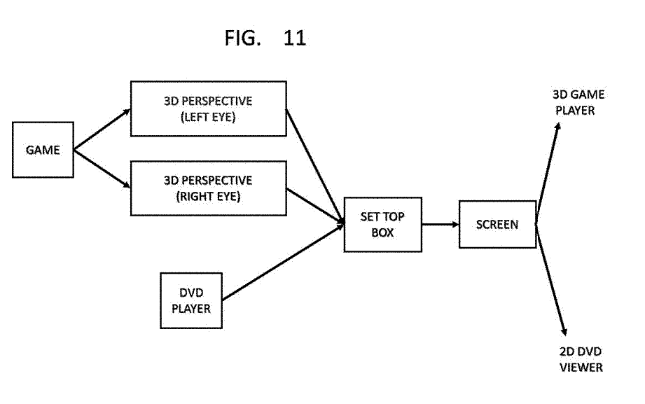

FIG. 3 illustrates three people watching different video entertainment programs. In one aspect of the present invention, each of them are wearing filter glasses with headphones, in accordance with the present invention and watching the same television 310. The first person's glasses are made to enable him/her to watch only the Soccer World Cup, 361 on the screen 310. The second person's glasses are made to enable him/her to watch only the Spiderman 2 movie, 362 on the same screen 310 and likewise the third person's glasses are made to enable him/her to watch only the TBBT episode, 363 on the same screen 310 without any interference from the rest. In this manner, a single television is used to watch and listen to multiple audio/video sources by persons 351-353 in both 2D and 3D presentations as depicted in FIG. 11.

Although the present invention has been described for particular embodiments, it is clearly evident that these embodiments are illustrative of the principles and applications of the present invention. It is therefore understood that further modifications may be made to the illustrative embodiments.

In view of the above, it will be seen that several objectives of the invention are achieved and other advantages attained.

All references cited in this specification are hereby incorporated by reference. The discussion of the references herein is intended merely to summarize the assertions made by the authors and no admission is made that any reference constitutes prior art. Applicants reserve the right to challenge the accuracy and pertinence of the cited references.

What is claimed is:

1. A system for providing respective video feeds to at least two viewers on a single screen, the system comprising
a control unit; and
a display connected to the control unit,
wherein the control unit is operable to control the display of different video signals at different frequency ranges on the same screen.

2. The system of claim 1, further comprising smart filter glasses which function depending on the signal from the processor and thus operates only when the intensity and frequency of the incident feed lies in the desired range.

3. The system of claim 1, further comprising a first audio unit along with the first filter glass and a second audio unit along with second filter glass, wherein the control unit provides sound associated with the respective video feed.

4. The system of claim 1, wherein the control unit is operable to synchronize the frequency of the first filter glass pair to the first video feed frequency to be presented to the first viewer and the second filter glass pair to the second video feed frequency to be presented to the second viewer.

5. The system of claim 1, wherein the control unit is operable to synchronize the left and right filter glasses to the range of defined frequencies, such that the left prospective and right prospective are different thus creating a 3D effect.

6. The system of claim 1, wherein the display comprises controllable pixels.

7. The system of claim 6, wherein the display is a light emitting diode (LED) television, or a plasma television.

8. The system of claim 1, configured so that each viewer can view only the contents of the screen, and everything except the video from the screen is darkened.

9. The system of claim 1, wherein the display utilizes projection technology.

10. The system of claim 9, wherein the projection technology is in a movie theater or in-flight entertainment.

11. The system of claim 1, configured so that only one viewer may optionally view a video output without smart filter glasses.
